(19) United States
(12) Patent Application Publication
(10) Pub. No.: US 2023/0336029 A1
(43) Pub. Date: Oct. 19, 2023

(54) WEARABLE BATTERY CHARGING CRADLE

(71) Applicant: Cynetic Designs Ltd., Kelowna (CA)

(72) Inventor: Roger J. SOAR, Kelowna (CA)

(21) Appl. No.: 18/300,657

(22) Filed: Apr. 14, 2023

Related U.S. Application Data
(60) Provisional application No. 63/330,977, filed on Apr. 14, 2022.

(51) Int. Cl. H02J 50/12; H02J 7/00; A41D 1/00; H01M 10/46; H01M 50/247

(52) U.S. Cl. CPC H02J 50/12; H02J 7/0044; H02J 7/00032; A41D 1/002; H01M 10/46; H01M 50/247; H01M 2220/30; A41D 1/04

(57) ABSTRACT

A wearable battery charging system includes a battery charging cradle having within it, in one embodiment, a rectification circuit, a battery charging circuit, and a wireless power receiving planar coil. The power receiving planar coil is sized for optimized wireless power charging of the battery when the power receiving planar coil within the cradle is brought into charging proximity to, and charging alignment with, a wireless power transmitting coil. The wireless power receiving planar coil may have a diameter which is at least five inches. The cradle is sized to snugly fit within the base of the pocket and to be compressed into the base of the pocket by the battery. The cradle is sized and shaped to correspond to the size and shape of, so as to fit snugly against, the base of the battery.

### FIELD

The present disclosure relates to charging cradles for charging a battery, and in particular to a wearable charging cradle to charge a battery with a minimum of cables and connectors.

### BACKGROUND

Most modern soldier system utilises a high-capacity battery as the central power source. The battery can be of multiple form factors, but a typical form factor is a low thickness, large area battery such as the Conformal Wearable Battery (CWB) that can be inserted into either a tactical vest hard armour plate pocket or into its own pouch attached to the back of the vest. The soldier central power source provides power to a variety of wearable electronic devices that the soldier carries such as radios, GPS device, enhanced vision devices, auxiliary rechargeable batteries, flashlights, powered environmental clothing or an end user device such as a handheld portable computer or cell phone type device as some examples. With the increasing number of peripheral electronic devices and increasing power demands, today's soldier must be able to optimise his individual power planning. For the most part, the following description of the various formats of the battery charging cradle will be discussed with a military use context. Although it is envisioned that the cradle will find most application with the military environment, there may also be applications within civilian roles such as paramilitary, police, fire, and search and rescue organisations; commercial roles such as construction and surveying, industrial applications within forestry, oil and gas exploration and recreational roles for example.

Before a soldier goes out on a mission, the central battery of a soldier system is charged using a charging adaptor or charging dock that may receive its power from a variety of AC and DC power sources. As power is consumed during a mission by the soldier system electronic devices, it is critical for the soldier to maintain and optimise the power levels in the system central battery to have a functioning soldier system.

The ability for a soldier to obtain charge for his central battery while on-mission is very difficult as both the infrastructure and ability to remove or even swap out batteries while on-mission are infrequent or simply impossible to do so safely if in combat situations. On-mission power logistic plans for the soldier must allow for them to take advantage of charging opportunities that readily present themselves to maintain their soldier system battery at optimal charge levels and therefore have the electronic devices being carried available for use.

When seated in a mobile platform, power is available from the vehicle power bus via direct connection using a conventional electro-mechanical connector and cable or by using wireless power transfer. Wireless power is defined as any system where electrical power is transmitted from a power source to an electrical load without interconnecting wires. Wireless power can be transferred across an air gap or through non-conducting materials or both.

In the early years of wireless power transfer development, wireless power systems were only able to provide between 50-100 W of electrical power from a transport platform seat such as that found in aircraft, vehicles, or vessels to a soldier power and data system (such as NETT Warrior). The wireless power connection enables the soldier system to connect to the vehicle power bus without the use of a conventional electro-mechanical connector. The soldier system power manager would then port the received wireless power to a battery charger which in turn would charge the soldier system central battery. Wireless power systems provide the ability to transfer power in extreme or austere environments that would present contamination, fouling or corrosion issues for conventional electro-mechanical connectors. Both planar coil and dongle type inductive power systems provide electric power to an independent soldier system power manager that in turn provides power to the soldier's system devices which may include a discrete Li battery charger that will the provide charge power to the soldier central battery.

Recent advances in wireless power transfer between the vehicle and the soldier are now providing increased power transfer and therefore increased charge capacities of up to 200 W or greater. As maintaining a soldier's central battery is critical to the performance and function of the soldier system, it becomes imperative that a soldier be able to obtain or scavenge power whenever an opportunistic situation presents. The most prevalent opportunity to secure opportunistic power is when the soldier is seated in a mobile platform such as a land vehicle, maritime vessel, or aircraft. On many occasions he may only be seated within the mobile platform for a short period of time, so it is crucial that the soldier be able to access as much power in a as short time period as possible. At the present time however, a soldier's access to power is limited by the multi-pinned cylindrical connector and the maximum power capacity of the cylindrical connector pins used to connect to the battery which are limited to five amps of current. With a 16.8-volt battery and a maximum current of five amps the maximum battery charge rate is limited to 85 W.

Presently a soldier system typically includes a vest with a rear armor plate pocket such as illustrated in FIG. 10A, and which may also used to carry a soldier system central battery or CWB. Alternatively, and most often a preferred configuration, is for the battery to be carried in its own pouch, which is attached to the back of the vest and placed over the plate pocket. To facilitate higher levels of charge to the CWB or other battery type when a soldier is being transported in a vehicle and when a battery is carried on the soldier system vest, we can take advantage of the flat charge terminals on the bottom of the battery as seen in FIG. 1. Charging the battery using the flat bottom terminals allows a greater charge rate than when using the battery's cylindrical connector. The high-capacity flat charge terminals on the bottom of the battery are intended for rapid charging of the battery using desktop or field chargers typically found in a forward base where mains or AC power is available. The contacts are rated for a minimum of eight amps, which may increase in future generations of battery. Opportunistic charging of the battery at eight amps would be a sixty percent increase over the maximum five amps that can be currently provided via the cylindrical connector, a significant increase. From an alternate perspective this means a sixty percent reduction in the time a soldier would need to receive an equivalent charge when the cylindrical battery connector is used. Integrating the WPT coil, rectification and battery charging circuit within the same housing eliminates several cables that would otherwise be points of failure. The integration of discrete electronic components within the cradle in addition reduces the footprint on the vest of the central battery charging system. Mounting space or available real estate on a tactical vest is extremely limited and finding an available space in the proper location for tactical equipment can be extremely challenging. Removing devices such as the battery charger and the RX coil rectification as individual components on the vest also enhances the utility of the cradle. A cradle that provides charge power and data via the battery flat terminals while the battery is stowed and carried on the vest within a mission is therefore a significant improvement to the present situation.

To facilitate on soldier mobile charging of a battery such as the CWB via the battery's bottom terminals, a man portable high power charging cradle or man portable charging dock may be used that is form factor compatible with the CWB or central battery, and would fit either in the rear plate pocket of the vest or in a purpose designed pocket that is used to the stow the battery and cradle, and that would attach to the rear of the vest over the rear plate pocket. The purpose designed pocket or plate pocket securely contains the cradle and battery. A soldier in a tactical environment will be required to march, walk, crawl, or run. It is imperative that when the soldier runs or places his back in a head down position such as when crawling, that the battery and cradle be held securely within the pocket into which it is placed. When the cradle is placed within a vest plate pocket, the cradle is held securely and snugly within the pocket by the sides of the pocket and against the bottom of the plate pocket by securing a hook and loop or buckle closed pocket top flap. A pocket purpose designed to hold the battery and cradle, in addition to the pocket sides and top flap, may also take advantage of internal straps, hook and loop tape or other means of securing the cradle to hold it snugly and securely within the pocket. The pocket may be substantially the same size of the front or rear of the vest, or may be smaller, for example and without intending to be limiting, no less than one quarter of the surface area of the front or rear of the vest.

Depending on the central battery design and configuration, high power contact charge terminals maybe located on any surface of the battery. The cradle design would therefore be modified to suit the location of the battery terminals as required.

A typical central soldier system battery is usually described as a smart battery and data exchange between the battery and a charger conform to the SMBus configuration protocols for example presently System Management Bus (SMBus) Specification Revision 1.1 and Smart Battery Data (SBData) Specification, version 1.1. and future specifications as they are made available.

The CWB is capable of being charged via both the NETT Warrior (cylindrical) connector and the charge terminal contacts on the bottom of the battery. The battery is capable of “wake up” charging via both the NETT Warrior connector and the charge terminal contacts. Typically, only four high power terminals are required the function of which are: V-Battery Ground, Charge+, SMBus Data, SMBus Clock. The battery is compliant with System Management Bus (SMBus) Specification Revision 1.1 and Smart Battery Data (SBData) Specification, version 1.1. The CWB is manufactured flat but maybe conformed after manufacture by the user to fit a curve. The CWB battery is capable of bending or conforming to a curved surface with a seven-inch radius.

The CWB has a cylindrical bi-directional low power (85 W, 5 amp) connector socket or receptacle that provides SMBus battery charge data exchange and charge input and power output. The connector maybe referred to as NETT Warrior connector. The multi-pin cylindrical connector socket allows a conventional means of providing up to five amps of charge power to the battery and is also used to deliver up to five amps of power from the battery. SMBus charge data exchange is provided through the connector from the battery to control the charge cycle of an external battery charger. On other battery models the connector socket may be of other geometric form factors such as smaller or larger cylindrical or rectangular formats. Soldier system batteries may also have secondary power output connectors such as a USB power connection.

The charging rates for Lithium batteries and for the transmission of wireless power within the context of this disclosure are rated as follows: low power means less than 30 W; medium power is less than 100 W; high power is greater than 100 W. Although the mobile charging cradle as disclosed herein is primarily intended for charging rates of greater than 100 W power input, in a preferred embodiment the charging cradle may also be used for charging rates with an input power of less than 100 W.

In addition to the plethora of conventional warfighting equipment he must carry, the modern soldier also has an array of electronic devices such as battery chargers, data and power managers, power distribution hubs and the central battery he carries on his back. These devices are interconnected through an assortment of traditional cables and connectors. To reduce both weight and size, the connectors have small pin and socket connections that are easily fouled and the wires within the cables are equally small, usually only 28 ga to 24 ga (0.025″-0.045″ diameter). The cables have flexible strain reliefs, frequently larger than the connector itself, to reduce the inevitable failure of the cable connection due to bending stresses. The cables themselves are a significant snag or unintended restraint hazard for the soldier, be it within the tight confines of an armoured personnel carrier or on the battlefield while maneuvering through heavy undergrowth.

Although there are no issues with the small wires and connector pins for charge power data communication, the NETT Warrior cylindrical connector specified by the US Army for Conformal Wearable Battery only provides a 24 ga power wire which has a maximum current rating of 5 A. With wires this small, power transfer efficiencies of 2-3% are lost with cable run lengths as short as 12″ and up to 5% loss with cable lengths of 24″.

The wireless power cradle provides a robust, integrated power solution that would otherwise be a myriad of system cables, connectors, and independent devices. Numerous advantages can be observed with the integrated wireless power cradle. Instead of the individual components of a conventional wireless power system which can be identified as: the wireless power coil with cable to the rectification circuit with a cable to the charge circuit with a cable to the battery; a total of four devices with three cables and six interconnects, the wireless power cradle reduces the system to two components (cradle and battery) no cables and only one internal contact between the battery and the cradle.

Such a significant reduction in cables and interconnects achieves many benefits. The reduction in cables provides the commensurate elimination of snag hazards, elimination of connector pin failures, elimination of interconnect wire to pin failures, improvement in power transfer efficiencies by up to 5% by removing resistive wire runs, system weight reduction by having no cables and connectors and finally, the weight reduction due to housing consolidation. In general failure rates from all sources by using the wireless power cradle are lower and system reliability is enhanced.

Only one cable will remain and that is the power out of the battery to the user system connection, which remains a common system element that cannot be removed.

What follows is a description of prior art of which applicant is aware.

Previous patent disclosures by Soar (U.S. Pat. No. 9,126,514 B2) have identified charging of a central battery such as the Conformal Wearable Battery (CWB) through its cylindrical soldier system or NETT Warrior connector. This cylindrical connector is limited to a maximum charge rate of 5 A. Soar does not indicate any integration within a common housing of the RX coil, rectification and charging circuits so as too eliminate the cables that would normally connect these individual components. In addition, Soar describes the mounting of the rectification and Li charging circuits as separate components mounted on the torso of the soldier and that they are integrated into the load carriage or tactical vest. The figures provided by Soar show the RX coil, secondary rectification circuit, battery charging circuit and battery as separate components, each in their own housings on the soldier's vest. No attempt or discussion is made to utilise the high-power flat terminals on the bottom of the battery which is placed into a system integrated housing containing the RX coil, rectification circuit and battery charging circuit, and provides the ability to eliminate all the interconnecting cables between these components.

In addition, there are multiple patents that cover multiple device iterations for charging battery powered handheld devices where the dock or cradle contain the TX coil and drive circuits and the cradle or dock is connected via a wire to vehicle power. They are affixed semi-permanently within cupholders or the center console of the vehicle and they do not leave the vehicle with the user when he exits the vehicle. Examples of such inductive charging docks for handheld devices would be Van Wiemeersch (U.S. Pat. No. 9,148,033 B2) and Arai et al., (U.S. Pat. No. 9,270,130 B2).

Examples of inductive charging on a seat include those by Margis et al., (U.S. Pat. No. 9,788,021 B2), who describes an aircraft seat video display system that has provisions below the video display to stow handheld devices and inductively charge them if the device was manufactured for inductive charging. Baarman (U.S. Pat. No. 7,612,528 B2) teaches placing a primary inductive circuit in a seat back which has a remote device holder and into which a rechargeable tool can be placed.

None of the above teach the application of wireless power transfer from a seat to a garment on a user's torso, with the garment containing a high-power central battery of a soldier system charged by an integrated battery charging cradle that the battery is placed into.

### SUMMARY

In summary, the present disclosure includes a wearable battery charging system for charging a battery which is sized to fit into a pocket on a tactical vest. The vest pocket has an opening into a pocket cavity, and the pocket cavity has a cavity base at the bottom of the cavity. The pocket is sized to fit onto a torso covering surface on the vest, for example the front or rear surface of the vest. The battery and pocket are adapted so that the battery is held snugly within the pocket when the vest is worn. In one embodiment the wearable battery charging system co-operates with a wireless power transmitting coil and associated electronics detached from the vest so as to charge the battery when, for example, the user is sitting in a chair equipped with the transmitting coil.

The wearable battery charging system includes a battery charging cradle having within it, in one embodiment, a rectification circuit, a battery charging circuit, and a wireless power receiving planar coil. The power receiving planar coil is sized for optimized wireless power charging of the battery when the power receiving planar coil within the cradle is brought into charging proximity to, and charging alignment with, so as to be parallel to, the wireless power transmitting coil. For example, the wireless power receiving planar coil has a diameter which is at least five inches. The cradle is sized to snugly fit within the cavity base of the pocket and to be compressed into the cavity base by the battery.

The cradle is sized and shaped to correspond to the size and shape of the base of the battery and to fit snugly against the base of the battery so as to, in the case of a planar battery, lie in the plane of the battery. The cradle has circuitry within the cradle which is adapted to transfer power from the power receiving planar coil to the battery when the cradle is snugly against the base of the battery. Advantageously the cradle does not have any cables leading into or out of the cradle. However, in one embodiment a data exchange and power-out connector may be provided on the cradle.

An outer circumferential dimension of the cradle, for example when measured around an upper circumference of the cradle where the cradle mounts against the battery, preferably substantially corresponds to an outer circumferential dimension of the base of the battery so that the cradle is conformal with the base of the battery when the power receiving planar coil is snugly adjacent against a face of the battery which is adapted for transfer of power to the battery and the battery and the cradle are mounted in the pocket of the vest so as to compress the cradle against the base of the battery and into the cavity base of the pocket. As used herein, substantially means to include small permutations, such as in shape or dimension, which do not detract from the described function of a particular element of the wearable battery charging system.

In one embodiment the wearable battery charging system includes a releasable securing means, as described more fully in examples detailed below, adapted to releasably secure the battery onto the cradle when the battery and the cradle are mounted in the pocket.

The cradle has a battery interface on a surface of the cradle facing the battery when the battery is on the cradle, wherein, in one embodiment, the battery interface has a battery receiving cavity into which the base of the battery snugly fits.

In a preferred embodiment the wireless power receiving planar coil, the rectification circuit and the battery charging circuit are adapted to receive wireless power from the wireless power transmitting coil, and to provide the received power to the battery in the range of zero to 300 W.

As used herein, reference to a pocket on the vest is intended to include not only pockets flush on the surface of the vest but also pouches that may be mounted externally on the vest. Further, reference herein to a pocket is not intended to convey only conventionally known pockets on tactical vests which cover a large portion of a front or rear surface of the vest, but also smaller pockets, for example a pocket which covers one quarter or more of the surface area of the rear of the vest.

Advantageously the battery is relatively thin. For example, the battery has a battery width, a battery height and a battery depth, and the battery depth is less than one fifth of the battery width. The cradle has a cradle width, a cradle height, and a cradle depth. In one embodiment not intended to be limiting, the battery width is the same as the cradle width and the battery depth is the same as the cradle depth, and the pocket cavity is correspondingly sized to receive snugly in the pocket cavity the battery and the cradle when the battery is mounted on the cradle. The cradle width may however be less than the battery width.

In a preferred embodiment the method for wireless power transfer is chosen from the group which includes inductive at operating frequencies between 20 kHz to 500 kHz, magnetic resonance at operating frequencies between 6 MHz to 7 MHz, magnetic resonance at operating frequencies between 13 MHz to 14 MHz.

In one embodiment the battery has a curvature to conform to a curvature of the torso of a user, and the cradle has a corresponding curvature. The cradle may be manufactured from rigid material or from semi-rigid material, or from a combination of these materials.

In embodiments intended to be within the scope of the present disclosure, the releasable securing means may include a strap or straps, a latch or latches between the battery and cradle, releasable adhesive, hook and loop fabric fasteners, male-female mating between the battery and cradle, one or more rigid arms which may include interlocking releasable mating of the arms, a tensioning fold-over pocket flap to push the battery and cradle into the cavity base of the pocket.

In further embodiments, the system does not include a wireless power coil or rectification circuit in the cradle and is adapted so the battery charging circuit receives power in the range of zero to 300 W from an external cable coupled to the cradle.

### BRIEF DESCRIPTION OF THE DRAWINGS

With reference now to the drawings, wherein like reference numerals represent similar parts in each view:

FIG. 1. shows one embodiment of a conformable wearable battery charging system;

FIG. 2 shows a view of one embodiment of a charging cradle of the system of FIG. 1;

FIG. 3. shows a view of a battery cradle that is configured for use with a conformable wearable battery;

FIG. 4. shows a view of a bottom side of a generic battery;

FIG. 5 shows a cross section of a generic charging cradle;

FIG. 6 is an enlarged view of a portion of FIG. 5 within a dotted circle;

FIG. 7 shows a charging cradle with a truncated length that does not extend for the full width of the battery;

FIG. 8 is a perspective view of a full width of a cradle cavity;

FIG. 9 is a perspective view of a truncated or partial width of a cradle cavity;

FIG. 10A shows a soldier or civilian wearing a charging cradle assembly;

FIG. 10B shows the soldier or civilian of FIG. 10A seated on a seat found within crew transports and the seat holding at least a wireless power transmitting (TX) coil assembly;

FIG. 11 shows a wireless power RX coil assembly integrated into the charging cradle assembly;

FIG. 12 is a section view of a cradle part of the integrated RX coil assembly and charging cradle assembly of FIG. 11; and

FIG. 13 shows an alternate configuration for the wireless power RX coil assembly integrated into the charging cradle assembly.

### DETAILED DESCRIPTION OF EMBODIMENTS

Description of the Central Battery Charging Cradle

The man portable high power charging cradle, alternatively described as a mobile high power charging dock, is comprised of a rigid, such as a polymeric or metallic structure that enables the connection to a battery that has pad like charge terminals and facilitates the transfer of low to high power charge rates, for example 0.1 to 8.0 Amps or higher. The high-power charge rates are battery design dependent but would be greater than the typical five amps provided by a conventional cylindrical connector, such as the NETT Warrior or connector. The charging cradle allows the battery to receive a high-power charge via the flat terminal connectors, that is not by the cylindrical pin and socket connector, of the battery while a soldier is being transported by a vehicle, aircraft, or vessel. In some embodiments the cradle may also facilitate the charging of a battery without removing it from a vest while at a base facility that is able to provide AC mains power.

The cradle includes: a cavity within a housing which receives and locates the base of the battery; where the housing contains, as required, printed circuits board or boards that hold electrical contacts; Li charging circuit boards and wireless power rectification boards, sprung connectors with a surrounding environmental seal; a means of securing the cradle to the battery; and, a power and data input connector socket or cable with attached connector.

The housing of the charging cradle structure which maybe manufactured using a structural synthetic polymer, diecast or machined metal, facilitates a secure position and alignment of the cradle power transfer sprung contacts against the flat contact terminal pads on the battery. The battery pads may be located on the top, bottom, or sides of the battery dependent on the manufacturer and design of the battery.

The battery cavity of the cradle is sized and shaped so that the inner circumferential dimensions of the cradle cavity correspond with suitable fit tolerance, to the outer circumferential dimensions and shape of the battery. The cradle cavity may be rectangular to receive a battery with flat surfaces or the cavity may be curved i.e., have a radius to receive a battery correspondingly shaped. The cradle may be constructed with a rectangular section cavity to retain the battery in position or alternatively any one or multiple sides of the cavity maybe omitted to allow among other capabilities a range of flex to the battery for instance with a CWB, instead of a fixed radius. The cavity in the cradle is used to position and secure the bottom of the battery against the cradle charge contacts. The cavity maybe of any depth but optimally the cavity is only required to be deep enough to secure the battery and as such the cavity may present as a rim. The walls of the cavity do not have to be continuous and may for example be castellated or be protrusions located in more than two locations as long as the battery is maintained securely in place. If the battery receiving cavity has a continuous wall it maybe provided with drain holes, slits, slots, or apertures to facilitate the draining of liquids, sand or debris that might otherwise accumulate within the cavity.

Other shapes of cradle may be required to suit different geometries of battery. An example of a different geometrical shape is a truncated charge cradle housing that only covers that portion of the battery required to make contact and seal against the high-power battery terminals. For a CWB, a truncated cradle or shoe also allows the battery to accommodate a range of radius placed upon it instead of a fixed radius.

A support feature or structure, for example strips or braces etc., maybe incorporated onto the cradle to provide support to that part of the bottom of the battery that has no terminals. The support feature ensures the bottom surface of the battery remains parallel to the cradle when the battery is docked within the cradle thus ensuring a surface parallel to the sealing surface and against which an environmental seal can be made.

The housing of the cradle is used to contain and physically protect components, printed circuit boards, and wired connections from external such as environmental influence. A cover attaches to the housing using any conventional means of securing and sealing a cover to a housing such as screws and elastomeric seal, chemical bonding, adhesive bonding, or ultrasonic welding among other techniques. Rather than have a rigid housing, housing materials maybe chosen that are semi-rigid and allow some flex of the structure so that the housing can conform to the flex of the CWB. In this case internal printed circuit boards are designed to accommodate housing flex.

Bars, slots, or other geometries of attachment structure may be placed on or into the cradle housing to facilitate the attachment of straps to secure the cradle to a battery. The cradle can be attached semi-permanently to the battery using retention straps that can be secured in a variety of means such as buckles or hook and loop fastener. The retention straps maybe directly attached to the cradle with specifically designed retention strap bars, pass through apertures within the housing or the strap or straps my simply wrap around both the cradle and the battery. A more permanent attachment of the cradle to the battery is the application of double side adhesive tape or chemical or adhesive bonding, preferably releasable, between mating surfaces of the cradle and battery. In future designs, the battery external case may be modified to incorporate but not be limited too, detents, protrusions, latches, or other case fixtures that allow a cradle to employ a semi-permanent mechanical means of attachment. That is the cradle can be attached directly to the battery and then removed without having to employ the use of straps, adhesives, or other ancillary securing devices.

The cradle battery power contacts are spring loaded or sprung contacts which would have a current rating greater than eight amps. The contacts would be surrounded, contained by, or be set within either individual or continuous strip elastomeric seals that when compressed between the battery and the cradle surface would create an environmental proof barrier to protect the contacts. The seal system would be rated to IP68 or better, allowing the cradle to be submerged or exposed to austere environmental events without experiencing any negative operational affects. The contacts are spring loaded such that when the battery is placed within the cradle cavity the cradle contacts are compressed and maintain contact with the opposing flat terminal on the battery. The cradle's sprung or spring-loaded contact maybe of several designs such as a sprung finger contact, but a pogo pin type sprung contactor is preferred due to its small cylindrical form factor and ability to carry high current loads.

Located on the cradle, for example on one end of the cradle is a high power (100-300 W, 5-12 amp) cylindrical input and SMBus charge data transfer connector socket to allow the connection or mating of an external high power source cable and connector. The connector socket such as a bulkhead connector socket would be used to connect and provide high-power input into the cradle with the power then provided to the battery high power charging terminals via the cradle sprung contacts. In addition to the provision of high current power, the connector would also allow the exchange of SMBus charge data between an external Li battery charger and the battery SMBus data contacts via the cradle contacts. Various configurations of cables and connectors maybe used, such as a single cable with connector or a Y-connection that provides separate cable connections for power and SMBus data into the cradle or a connector with a rectangular profile for example. The connector socket would be environmentally sealed against the cradle housing.

An alternate option for providing high power to the cradle in place of a bulkhead connector socket is to employ an external connector on a cable lead. The cable lead would have a molded stress relief that also provides an environmentally sealed cable entry into the cradle housing.

As required either the output power and charge data connector or output connector may be used to also provide the transfer of data from a high-speed data transceiver radio transceiver module. The transceiver radio module in the cradle provides short-range high-speed wireless data communication too a transceiver embedded in the back of the vehicle seat or other close proximity location. The vehicle radio transceiver would be connected to the vehicle data bus and the cradle transceiver module would be connected to the soldier system. The radio module would be able to communicate using wireless data communications such as Wi-Fi, Bluetooth, Ultra Wide Band spread spectrum among others. The radio module would be a complementary addition to the cradle as it would facilitate the transfer of both wireless power and data between the vehicle and the soldier.

Cradle Configurations

The charge cradle, which may be described as a man portable charging dock or wearable battery docking station may be constructed in several configurations as discussed below.

Charging Cradle Electrical Power Sources

The charging cradle may receive power from two principal sources, either via an external electric power cable or from an integrated wireless power receiver. An external electrical power source provides DCV power either directly to the charging cradle or to the soldier system which in turn passes the electrical charging power to the charging cradle. The DCV power maybe sourced from a vehicle, aircraft or vessel and can be through a conventional physical connector.

When on-mission, stationary accessible power sources such as solar panels and portable power generators maybe used. In a barrack environment when the soldier is either wearing the vest or has doffed the vest within which the charging cradle resides, the battery can be charged at a high rate without removing the battery or cradle from the vest using the DCV output of a power adapter plugged into ACV mains. For a cabled power connection, the cradle maybe equipped with a bulkhead type connector to allow the connection of a detachable power delivery cable or the power cable maybe a permanent and integrated cable into the cradle housing with a connector on the cable to connect to other electrical systems or power sources.

An alternate method for the charging cradle to receive power is from an integrated wireless power receiving (RX) coil which receives wireless power from a vehicle seat equipped with a wireless power transmitting (TX) coil. This option is described, for example, in more detail in the next section.

The cradle can be adapted to any battery configuration or design that has high charge rate contacts. The cradle can be placed on the battery flat terminals and then the battery can be rotated and placed in any position along the batteries vertical or horizontal axis.

On the cradle charger, the input power can enter the cradle from any face of the cradle, i.e., left, or right side, front or back face or bottom, as dictated by the soldier system requirements and its connectors.

The cradle charger can provide power transfer from 0-300 W or greater. Ultimately, the upper limit of the cradle charging power is not determined by the design of the charging cradle but is dependent in the future by, battery operating voltages, battery capacity, battery cell structure and design that in turn determine maximum charge rates that are allowed to be provided to the battery inserted into the cradle.

Charging Cradle Mechanical Configurations

There are four principle mechanical configurations for the charging cradle. A straight version that would take a flat battery, a curved cradle that would accommodate a battery with a radius, a truncated cradle that does not extend for the full length of any given side of the battery and a cradle with integrated wireless power coil. The latter maybe included in any of the first three configurations. In all of the cradle configurations described below and presented in the figures the mechanical layout is not intended to be limiting and the battery and cradle maybe in left or right hand, or inverted versions.

Charging Cradle Dock, Contacts Only

In this configuration the charging cradle has no embedded electronics with the cradle being only a physical structure to provide connection between an external charging power cable and connector and the flat or high power and data terminals on the battery. Charging power to the cradle and in turn to the battery via the cradle battery sprung contacts, is provided by an external cable and connector that is connected to an external Li battery charger or a soldier power manager with battery charging capabilities. SMBus charge status and smart battery health data is provided back from the battery SMBus data terminals via the cradle contacts to the power or charge manager which controls the charge rate of the battery, according to SMBus smart battery charge criteria. The charge cradle may accept charge power and battery charge data control from soldier mounted charging devices if the soldier is mobile. If in a stationary barrack type facility with AC mains power the cradle facilitates the rapid charging of the central battery without removing it from the vest using conventional desktop type charging systems. Power is withdrawn from the battery to be used by the soldier system via the cylindrical NETT Warrior connector.

The spring-loaded cradle battery power contacts would be surrounded, contained by, or set within either individual or continuous strip elastomeric seals.

The contact only charging cradle cavity maybe straight in order to receive a flat battery, it may have a curved cavity to accommodate a battery with a radius or be a truncated cavity that does not extend for the full length of any given side of the battery. The environmentally sealed housing of the cradle would be form factor compatible with the shape of the cradle cavity. DCV input power would enter the housing via a sealed electrical socket such as a bulkhead connector socket that is compatible with a mating connector and cable assembly. Alternatively, the socket can be replaced by a cable and connector assembly that mates with the DC power source on the soldier vest or an external source. The cable would enter the cradle housing via a molded strain relief that provides an environmental seal around the cable entry into the cradle. The only PCB contained within the housing is to carry the sprung high-power connectors and provide a means of connecting the input power to the sprung connectors.

Cradle Dock with Integrated SMBus Smart Battery Charger

The cradle charger or mobile charging dock with integrated SMBus smart battery charger in addition to the description and features of the contact only battery cradle incorporates within the housing a five amp or greater, such as an eight-amp SMBus smart battery charger Printed Circuit Board Assembly (PCBA). The smart battery charger is provided input power from the cradle external cable connection. The smart battery located within the cradle cavity receives charge power via the high-power battery cradle contacts, while the SMBus charge control data is exchanged via the data cradle contacts connecting to the battery flat charge and data terminals. An external Li battery charger is not required to charge the battery. Power is provided to the charger when the soldier is mobile as in a vehicle, from a soldier mounted remote power source such as a wireless power transfer system or a direct connect cable connection to a soldier power manager. If the vest has been removed by the soldier the cradle charger allows the use of a stationary or barracks supplied DC power source. Power is withdrawn from the battery to be used by the soldier system via the NETT Warrior cylindrical connector.

Cradle Dock with Integrated Wireless Power and SMBus Smart Battery Charger

The cradle charger or mobile charging dock with integrated wireless power and SMBus smart battery charger, in addition to the description and features of the charge cradle with SMBus Smart Battery Charger, also integrates a wireless power secondary or receiver (RX) system. The wireless power RX system includes an integrated RX coil and rectification circuit for the RX coil Alternating Current Voltage (ACV) output, the output of the rectification circuit is passed to the Li battery charger within the cradle charging system. Through the application of a primary or transmitting (TX) coil system in a vehicle seat, electrical power is transferred wirelessly between the vehicle seat back and the soldier's vest by the soldier sitting in the seat. This places the RX coil in the soldier's vest in proximity to the TX coil in the seat back, enabling wireless power transfer across the air gap from the seat to the soldier vest. The vest charging cradle with integrated wireless power RX maybe inserted into an existing plate pocket on the vest or attached over the plate pocket using a dedicated pouch. The RX coil is housed and environmentally sealed within the same polymer enclosure as the cradle housing with both the coil and cradle housing integrated as one unit.

The wireless alternating current (AC) power received by the RX coil is rectified and converted to direct current (DC) power on a rectification PCB that is contained with the cradle electronic circuit housing. The rectified AC power is output as DC power and input to the SMBus smart battery charger PCB charger which is controlled by data exchange with the SMBus battery located within the cradle cavity via the data cradle contacts connecting to the battery SMBus data flat terminals. The wireless power transmission system can provide from OA to greater than 8 A of charge power to the flat high-power terminals of the soldier system battery located within the charging cradle. As the ability of new battery designs allows greater charge rates to be placed into them, then the wireless power output can also be increased accordingly.

The soldier battery placed into the charge cradle is charged and data is exchanged via the high-power battery cradle contacts and charge control data is exchanged via the SMBus charge data contacts.

Power is withdrawn from the battery to be used by the soldier system via the battery's NETT Warrior cylindrical connector. Alternately if required, a high-power connector on a cable or alternately a bulkhead connector socket maybe placed on the cradle housing to allow the transmission of rectified power received by the wireless power RX coil to be provided directly to the soldier system where the power can be distributed by the soldier system power and data manager. This power path allows devices on the soldier to be provided with power directly, without the power having to pass through the soldier battery.

The transmitter wireless power coil is environmentally sealed in a polymer enclosure and maybe inserted into a pocket or pouch positioned on a fabric sling seat back, slipcover or seat with fully integrated seat back coil pouch or similar as typically found in troop transport vehicles, aircraft, or vessels. The wireless power TX drive circuit, to which the TX coil is attached via a short power transmission cable, is contained within a ruggedized housing mounted on the seat back or to the structure of the vehicle in close proximity to the seat. The TX drive circuit can provide from 0-300 W or greater ACV drive signal to the TX coil. The wireless power primary TX drive circuit is connected to the DCV vehicle power supply interface.

The transfer of wireless power, that is the transfer of electrical power across an air gap or space occupied by non-conductive materials maybe facilitated using several wireless power technologies. Within this disclosure the transmission of wireless power is discussed using the application of inductive, magnetic resonance and capacitive power transfer. For inductive power transfer, a planar alternating current primary or transmitting (TX) coil in a seat back couples with a planar alternating current magnetic field secondary or receiving (RX) coil on the battery cradle. Close coupled inductive power transfer typically utilises but is not limited too frequencies between 20 to 500 kHz, with a typical power TX frequency being around 100 kHz. Alternately, loosely coupled planar transmitting and receiving coils and associated drive, control and rectification circuits may employ magnetic resonance wireless power transfer with resonant operating frequencies between 6-7 MHz and 13-14 MHz, with typical operating frequencies of but not limited too 6.78 MHz and 13.56 MHz. Based on the principles of electromagnetic resonance, resonant-based chargers inject an oscillating current into a primary TX coil to create an oscillating electromagnetic field. A secondary RX coil with the same resonant frequency as the TX coil receives power from the electromagnetic field and converts it back into an electrical current that can be used to power and charge devices. An example of a such a system is one that follows specifications of the AirFuel Alliance. Other wireless power transmission protocols maybe used that are based on a resonant coupling principle for wireless power transmission. A further alternative is the application of inductive wireless power TX and RX coils constructed as a Multi-layer Self-Resonant Structures (MSRS) where the wire conductive element of an inductive or magnetic resonant coil is replaced with a multilayer insulated foil structure that operates with a nominal operating frequency of 6.78 MHz or other resonant frequencies as maybe determined to be practical. Wireless power transfer may also be based upon capacitive coupling between conductive electrodes with signals transmitted and received by alternating the electric field on the electrodes instead of utilising an alternating magnetic field.

The wireless power RX rectification circuit to convert the received AC current to DC maybe of many circuit topologies but a preferred configuration is one that optimises rectification efficiencies such as a fully synchronous circuit topology.

Wireless power seat back planar coil systems can provide power transfer from 0 W to in excess of 200 W with the potential for even greater power levels depending on soldier system demand. The upper limit of the power demand is determined by battery capacity, maximum battery allowable charge rate and the number and type of soldier system devices and their combined power draw requirements.

A functional wireless power charging cradle system may be built to any of the wireless power transfer specifications or standards that provide greater than 10 W of power transmission. Some of the specifications or standards maybe limited to the amount of power that can be transmitted in their current revision, however increased power transmission is typically foreseen for all specifications. Alternative wireless power transmission systems may also be designed that do not conform to an existing standard but incorporate Pulse Width Modulated (PWM) TX coil drivers and partial or full rectification of the signal received by the RX coil. Proximity sensing of the RX coil to the TX coil may be used by the wireless power system to prevent inadvertent coupling of power to none target metal bodies. Sensors in the TX coil assembly may also be used to identify the proximity of the RX coil using but not limited too hall effect, NFC and RF protocols such as but not limited too Radio Frequency Identification (RFID), low energy Bluetooth, Internet of Things (IOT), Wi-Fi, ZigBee among other proximity sensing techniques that provide entity identification and discrimination before allowing power transfer to the RX coil system. Additionally, proximity of the RX coil to the TX coil maybe accomplished using the wireless power signal as a carrier wave as identified in the Qi and AirFuel Alliance wireless power standards. Other proprietary polling techniques are used in wireless power integrated circuits (IC) that do not follow a specific standard, may also be used if the IC is utilised within the cradle system.

To obtain optimal power transmission, the RX coil should be no smaller in diameter than 50% of the diameter of the TX coil and no more than 50% bigger than the TX coil. A typical diameter for a TX seat coil is 10 inches as this size both works well for integration into the seat and allows the appropriate size coil to fit on a military or police tactical vest. The shape of the TX and RX coils maybe round, elliptical, square, or rectangular with or without rounded corners. In addition, the TX coil maybe singular, a pair or there maybe an array of coils that utilise a smart multiplexer that senses which coil should be the optimal primary power transmitter coil for a given RX coil position. This would be one way to accommodate enhanced alignment of the TX and RX coil to provide improved power transmission efficiency when users with different torso heights use a common seat.

The structure or morphology of a planar coil for the purposes described herein, are coils that have a diameter than is greater than ten times the thickness of the coil winding or conductive element. The coil maybe be wound from any type of wire with insulation between the winds either on the wire itself or as part of the coil retention structure. The coil maybe wound with all types of wire from single conductor to multiconductor structures using complex litz wire layups or stacked printed circuit board coil structures. Further in the case of a multi-layer self-resonant structure, the coil can be constructed from multiple layers of foil that are layered between a non-conductive substrate or dielectric material. The non-conductive substrate may be supporting (i.e., a printed circuit board structure) or a non supporting, non rigid substrate.

Depending on the coil design and the type of wireless power coupling employed, the coil may or may not require a secondary structure such as a ferrite backing or other materials to provide directional wireless power transmission and enhance coupling between the TX and RX coil to improve power transfer efficiencies. The ferrite backing may be tiles of various geometries, rigid or flexible ferrite sheet formats. The design of the primary TX and secondary RX wireless power coils provides power transfer efficiencies of up to 95%, with very low stray magnetic flux.

Given a TX coil with for example a 10-inch diameter, the effective transmission distance for a low frequency 50-500 kHz, power transfer will be provided over a coil separation distance 0 to 3 inches from the seat back TX coil to cradle RX coil. For loosely coupled coils such as magnetic resonance coils and MSRS foil coils typically operating in but not limited to a frequency range of 6-7 MHz and 13.56 MHz, wireless power transfer is provided over a coil separation distance of 0 to 12 inch from the seat back TX coil to the cradle RX coil.

The wireless power cradle maybe designed such that the integrated RX coil is located on any face of the battery that does not house the flat charging terminals and whereas the RX meets all other required operating conditions previously stated. A typical battery face against which the coil would be located against and conform too, without intending to be limiting, would be a face that is wider than for example a narrow edge face of a battery.

The housing of the coil within the cradle structure provides the most compact combined battery and cradle structure by conforming to the shape or curvature of the battery, that is the cradle is shaped and sized to correspond to the battery's mating face.

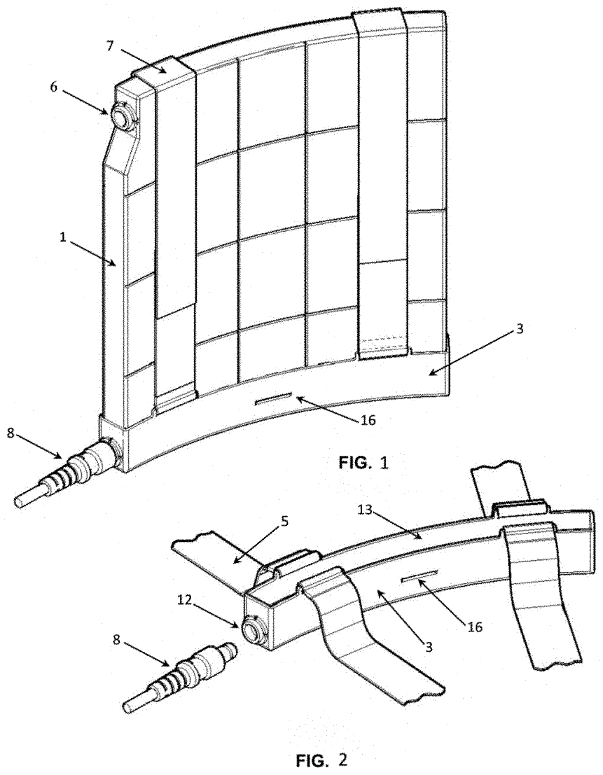

With reference now to the drawings, wherein like reference numerals represent similar parts in each view: FIG. 1 shows one form of soldier system battery, a Conformable Wearable Battery (CWB) 1 that is shown with an arbitrary bend radius placed upon it. The CWB is manufactured flat but maybe conformed after manufacture to fit a curve. The CWB has a cylindrical bi-directional low power (85 W, 5 amp) connector socket or receptacle 6 that provides SMBus battery charge data exchange and charge input and power output. The connector maybe referred to as NETT Warrior connector. The multi-pin cylindrical connector socket 6 allows a conventional means of providing up to 5 amps of charge power to the battery and is also used to deliver up to 5 A of power from the battery. SMBus data is provided through the connector from the battery to control the charge cycle of an external battery charger. On other battery models the connector socket 6 may be of other geometric form factors such as smaller or larger cylindrical or rectangular formats. Soldier system batteries may also have secondary connectors (not shown) such as a USB power connection. Straps 7 shown closed, are provided to be able to secure the battery once is it is placed within the charging cradle 3. Openings or voids 16 maybe placed at locations on the side or ends of the cradle housing that permit fluids and fine debris to drain or be ejected from the cradle that may otherwise accumulate within the cradle during use. The CWB and charging cradle would be placed within a pocket (not shown) on a soldier's tactical vest and be connected to a soldier's power and data system via connector 8.

FIG. 2 shows a view of the wearable high power battery charging cradle 3 with curved shape to accept and provide a bend radius to the CWB 1. The radius of the cradle curve may range between being flat to the maximum bend radius of the CWB, which presently is approximately seven inches. Other shapes of cradle may be required to suit different geometries of battery and are intended to be within the scope of the present invention. The charging cradle 3 is shown with an open strap 5 that when closed is used to secure the battery within the cradle. The cradle 3 could also be secured to the battery 1 using semi-permanent attachment methods such as but not limited too double-sided adhesive tape, hook and loop fastener, web strap system or be permanently bonded to the battery. A cavity 13 in cradle 3 is used to position and secure the bottom of the battery. The cavity 13 maybe of any depth but optimally its is only required to be deep enough to secure the battery. The walls of the cavity 13 do not have to be continuous and may for example be castellated, as long as the battery is maintained securely in place.

Located on the cradle 3 is a cylindrical high power and SMBus charge data transfer connector socket 12 to allow the connection or mating of an external high-power cable and connector 8. The connector socket 12 would be used to provide high power charge through the cradle to the battery via the batteries high power charging contacts (not shown). In addition to the provision of high current power, connector 8 would also allow the exchange of SMBus charge data to the battery SMBus data contacts via the cradle contacts. Various configurations of cables and connectors maybe used, such or a Y-connection that provides separate cable connections for power and SMBus data into the cradle or a connector with a rectangular profile for example. The connector socket 12 would be environmentally sealed against the cradle housing 3.

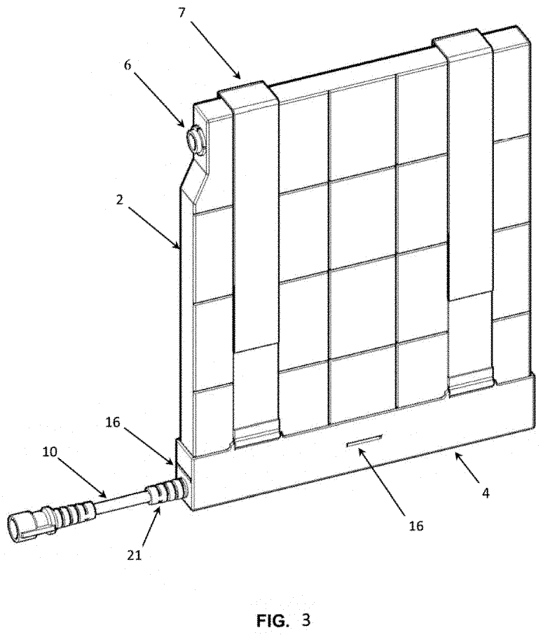

FIG. 3 shows a battery cradle 4 that is configured for use with a CWB 2 that is presented flat or with no superimposed radius. An alternate option for providing high power to the cradle instead of a connector socket is to employ an external connector 10 on a cable lead. The cable lead would have a molded stress relief 21. The molded stress relief also provides an environmentally sealed cable entry into the cradle housing.

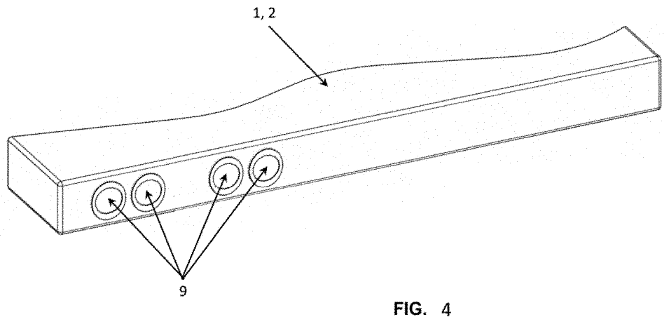

FIG. 4 shows the flat contact terminals 9 on bottom side of a generic battery 1, 2 that may be either flat or have a curvature. The flat terminals 9 include but are not limited to two high power (capable of 8A or greater) charging (battery positive and negative) and two low power terminals for SMBus data communication (Serial Clock—SCL and Serial Data—SDA). The terminals 9 may be placed at any location on the battery 1, 2 and not always be on the bottom edge. The design of the cradle could be changed to accommodate the arbitrary location of the battery high power and data terminals 9 but the purpose and function of the cradle would remain unchanged.

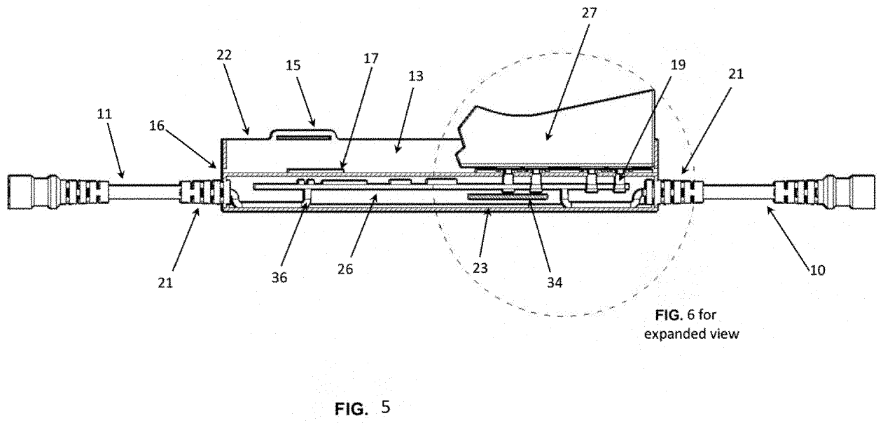

FIG. 5 shows a cross section of a generic charging cradle 22 with a cavity 13 and drain openings 16 to receive a battery 27 that maybe either flat or curved. If required, bars 15 or other geometries of attachment structure may be placed on the cradle to facilitate the attachment of straps to secure the cradle to a battery. A molded feature 17 maybe incorporated to provide support to the end of the battery that is without contacts. The support feature 17 ensures the bottom surface of the battery is parallel to the cradle when the battery is docked within the cradle to provide a flat surface against which a seal can be made. A cradle housing cover 23 provides a physical seal and structural surface to the cradle electronic compartment 26. The cover is attached to the housing using any conventional means of securing and sealing a cover to a housing such as screws and elastomeric seal, chemical bonding with adhesives or ultrasonic welding among other techniques.

An input power and charge data cable and connector 10 to the charging cradle and an optional output power and data cable and connector output 11 from the cradle charger may be replaced with connector sockets as required. The optional power out connector 11 allows excess power not needed for battery charging to be ported to other soldier or civilian system devices either directly or more typically too a vest mounted power and data system manager. The connector would be of a configuration to interface with the soldier or civilian system.

Within the sealed component compartment 26 of the cradle 4, reside circuits and Printed Circuit Boards (PCB's) that facilitate the application of the cradle to provide high power charging and other optional data capabilities to a battery. Sprung connectors 19 provide the physical connection between the charging cradle and the contact terminals on the battery.

As well as providing a power connection between the charging cradle and the battery, the PCB's and associated circuits and components also facilitate the SMBus data connection to allow smart charging of the battery, regardless of whether the SMBus smart charger is internal to the cradle or external.

Either the output power and charge data connector 10 or output connector 11 may be used to provide the transfer of data from a high speed data transceiver radio module 34 that provides short range high speed wireless data communication too a transceiver embedded in the back of the vehicle seat. The vehicle radio transceiver would be connected to the vehicle data bus and the cradle transceiver module would be connected to the soldier system. The radio module would be able to communicate using wireless data communications such as Wi-Fi, Bluetooth, Ultra Wide Band spread spectrum among others.

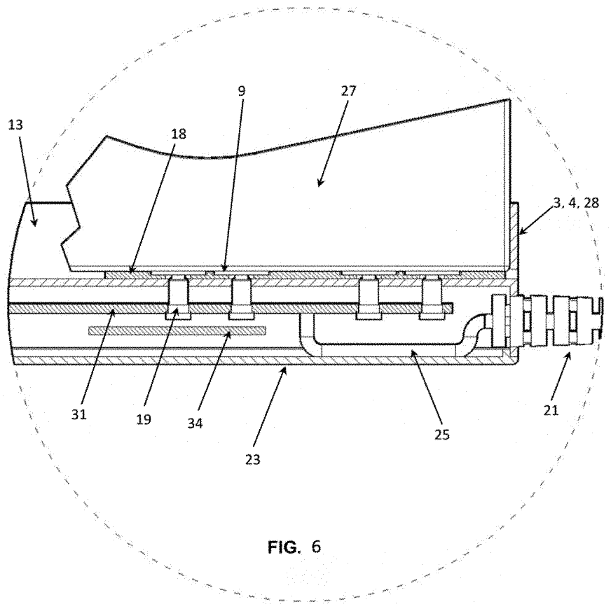

FIG. 6 is an enlarged view of a portion of FIG. 5 and is representative of a straight, curved or truncated cradle 3, 4, 28, 52 showing detail of the cradle connector board 31 with a generic soldier system battery 27 placed within the cradle cavity 13 and connection between the cradle sprung connectors 19 and the battery flat terminals 9. An elastomeric or similar conforming material provides a seal 18 between the battery terminals 9 and the cradle 3, 4, 28, 52 to provide protection from the external environment. A battery terminal contact seals maybe an individually placed around each terminal, a continuous strip that is flat or with formed features to provide optimal sealing characteristics between the battery and cradle mating surfaces.

Sprung connectors 19 such as but not limited to pogo pin or leaf spring connectors are mounted on a carrier 31 Printed Circuit Board Assembly (PCBA). The sprung connectors 19 provide the physical connection between the charging cradle 3, 4, 28 and the contact terminals 9 on the battery 27. The battery terminal PCB 31 maybe connected directly to the power input wires 25 if an external Li battery charge controller is utilised or to an internal Li charger controller PCB (not shown). A smart Li battery charging board internal to the cradle would be utilised if the charging cradle was directly provided with DC power from an external power source. External DC power maybe provided from a wireless power source, directly from the vehicle DC power bus, a DC power generator or AC mains power converted to DC.

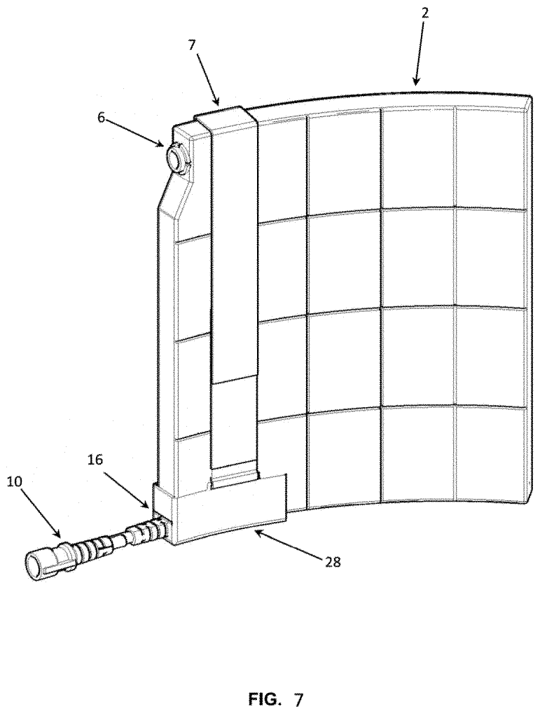

FIG. 7 shows a charging cradle 28 with a truncated length that does not extend for the full width of the battery. The CWB 2 that is shown for illustration purposes has an example of an arbitrary radius placed upon it. A charging cradle that is truncated allows the user to place an unspecified radius on the battery to suit changing fit requirements within the soldier's tactical vest. Depending on the format or geometry of the soldier system battery the truncated charging cradle or shoe maybe positioned on any portion of the battery that supports the high capacity charge terminals. The cradle 28 could be secured to the battery 1 using semi-permanent attachment methods such as but not limited too double-sided adhesive tape, hook and loop fastener, web strap system or be permanently bonded to the battery.

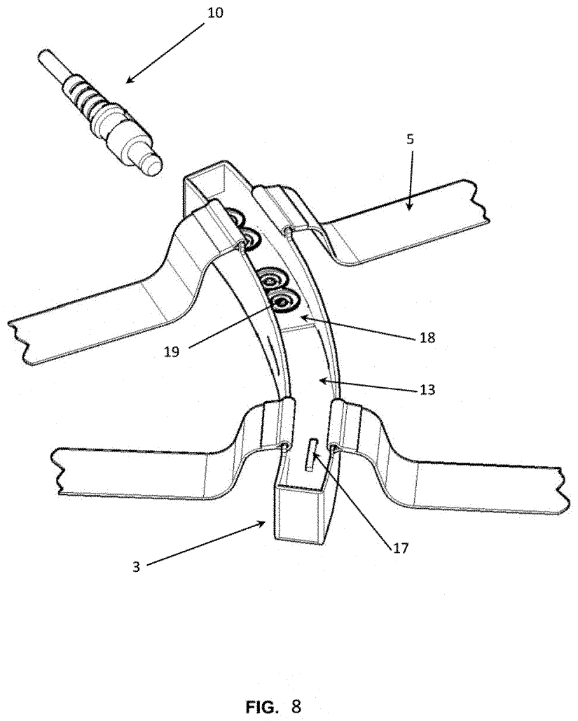

FIG. 8 is a perspective view of a full width cradle 3 cavity 13 showing the support structure for the battery 17, cradle to battery seal 18 and sprung connectors 19. For illustration purposes the cradle is shown with a radius as it would be to accept a battery that is curved. The same features shown would also be present for a cradle that is straight to accept a flat battery. The seal 18 may extend the full length of the cavity or only occupy a part length of the cavity as shown.

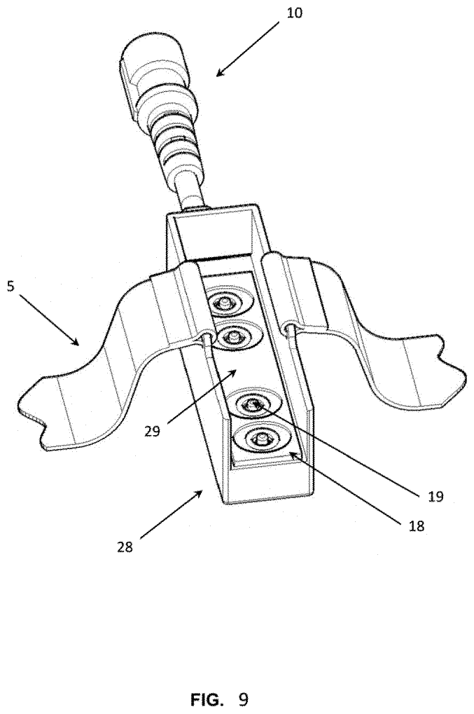

FIG. 9 is a perspective view of a truncated or partial battery width cradle 3 cavity 29 that is open at one end, with cradle to battery seal 18 and sprung connectors 19. A partial cradle only covers that portion of the battery with the charging and data contacts.

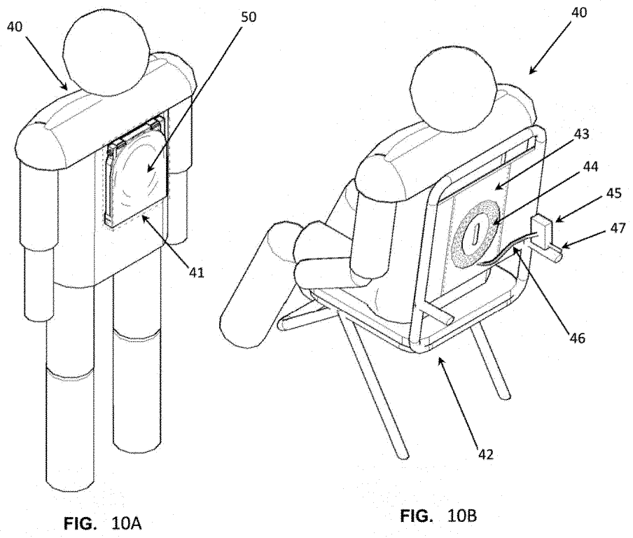

FIG. 10A shows a soldier or civilian 40 (hereinafter soldier 40) wearing a vest or other garment (not shown) that has a pocket 41 on the rear of the garment that allows the insertion and capability to carry an integrated wireless power RX coil and high power charging cradle assembly 50 with installed central battery or in the case of a soldier, a soldier system battery. Soldier 40 is presumed to carry equipment having high electrical power needs.

FIG. 1013 shows a seat 42 representative of all types found within crew transports that would include vehicle, aircraft, and vessels. Seated on the seat is a soldier 40, as previously shown standing in FIG. 10A. The seatback 43 maybe of various designs found within vehicle, aircraft, or vessels. Seat back 43 maybe part of the original seat, an after-market addition or after market replacement and be a fabric sling back, secondary seat cover or be fully integrated as part of the seat. The seat back is adapted to hold a wireless power transmitting (TX) coil assembly 44 in the correct position to provide wireless power transfer to the wireless power receiving (RX) coil of the integrated RX coil and charging cradle (as shown in FIG. 10A, 50) located on the soldier's garment. The seat back would have a coil pouch, pocket, hook and loop attachment or other means of securing the TX coil assembly 44 in the correct position to transmit wireless power to the RX coil. The wireless power TX coil assembly 44 is contained or held on the soldier side of the seat back or seat cover. As required, to accommodate a greater range in vertical connectivity between the TX and soldier RX coils, a second or multiple TX coil assemblies (not shown) may be added to the seat that either overlap or are adjacent to the other TX coils. The TX coil driver electronic circuit senses and drives the appropriate coil depending on which coil is more aligned with the RX coil on the soldier. The TX coil may utilise various formats of low or high frequency wireless power transfer, including but not limited too loosely coupled, highly coupled and magnetic resonant configurations.

The wireless power TX coil assembly 44 is provided the power drive signal from a TX drive electronic enclosure 45 which contains the TX drive electronic power circuits. A TX coil signal cable 46 provides the power signal from TX drive electronics enclosure 45 to the TX coil assembly 44. A DC power cable 47, connects to and provides DC power input to the TX drive electronics 45 from the vehicle, aircraft, or vessel power bus.

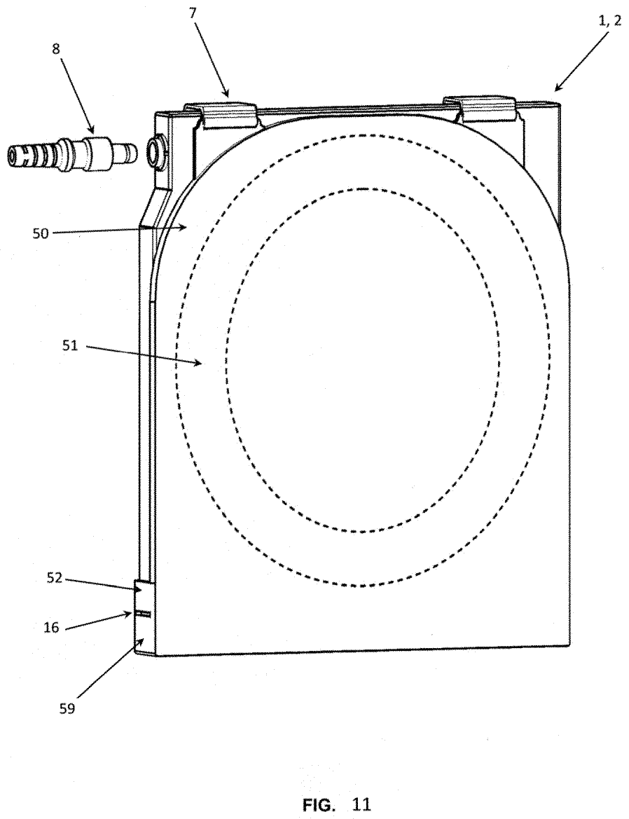

FIG. 11 shows a wireless power RX coil 51 assembly housing integrated onto a high power cradle charging assembly as a single fully contained system 50. A separate and removable high capacity battery 1, 2 such as a soldier system battery can be inserted into the battery receiving cavity or cradle 52 within the power charging assembly so that it can receive a charge directly from the wireless power system via the internal charge contacts of the charging unit. The cradle 52 and RX coil assembly may be constructed to receive a battery in a flat form, or the cradle maybe configured with a radius to impart a radius to the battery. The cradle housing 59 contains the RX coil wireless power signal rectification circuit, SMBus Li ion battery charging circuit and sprung contacts to pass power and receive SMBus charge data to and from the battery terminal pads. As required, securing straps 7 may be used to hold the battery securely within the cradle. Alternately the battery maybe secured to the cradle using double sided adhesive tape or more permanent bonding techniques.

Polymer or nonconductive materials are used for both the TX coil assembly enclosure 44 and the integrated RX coil assembly enclosure 50 for secondary (RX) coil.

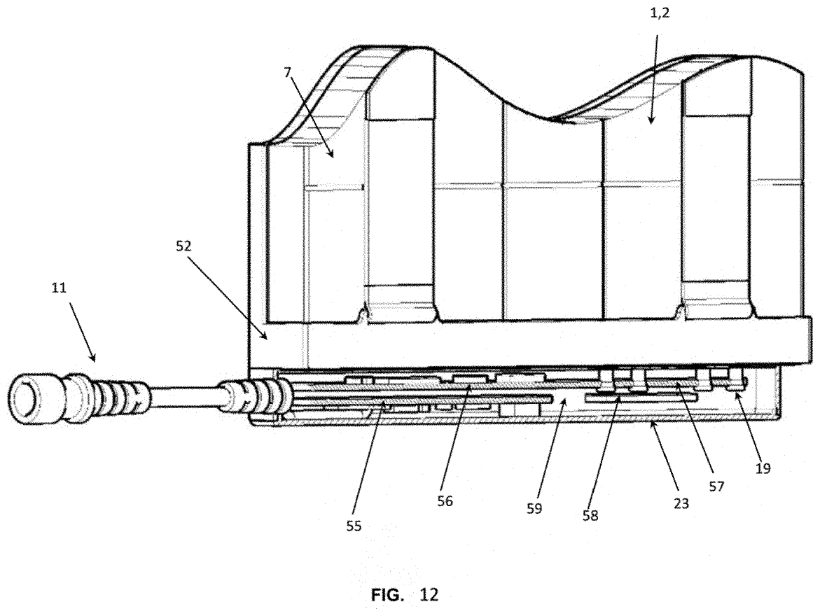

FIG. 12 is a section view of the cradle part of the integrated RX coil and charging cradle assembly enclosure 52 showing the PCB's required for the RX wireless power system to function. The charging cradle enclosure has a cover 23 that maybe a polymeric composite or metallic that seals and provides both permanent or one time access depending on the means of fastening it to the enclosure. The cover maybe attached so it maybe removed as required using screws and an elastomeric seal or it maybe used to permanently close the housing attaching it to the housing by ultrasonic welding, solvent welding, or adhesives. Within the cradle housing 52 electronics enclosure 59 are PCBA that include the rectification circuit board 55 for the rectification and optional output regulation of the wireless power signal received by the RX coil, the SMBus Li ion battery charging PCBA 56 and the power and data sprung connector carrier board 57 which supports the power and data contacts 19 from the cradle to the battery terminals. As required by design, functional circuits maybe on individual boards or the functional circuits maybe combined on a common board. In addition, within the enclosure maybe a high data rate radio module 58 such as but not limited to Wi-Fi, Bluetooth or UWB communication to facilitate the transmission of high speed data between the vehicle and the soldier system. A connector 11 on a cable or alternately a connector socket maybe placed on the cradle housing to allow the directly to the soldier system where the power can be distributed by the power and data manager. This power path allows devices on the soldier to be charged directly without the power having to pass through the soldier battery. Connector 11 would also be used to connect wireless high speed data received by the radio data module 58 to the soldier or civilian data system.

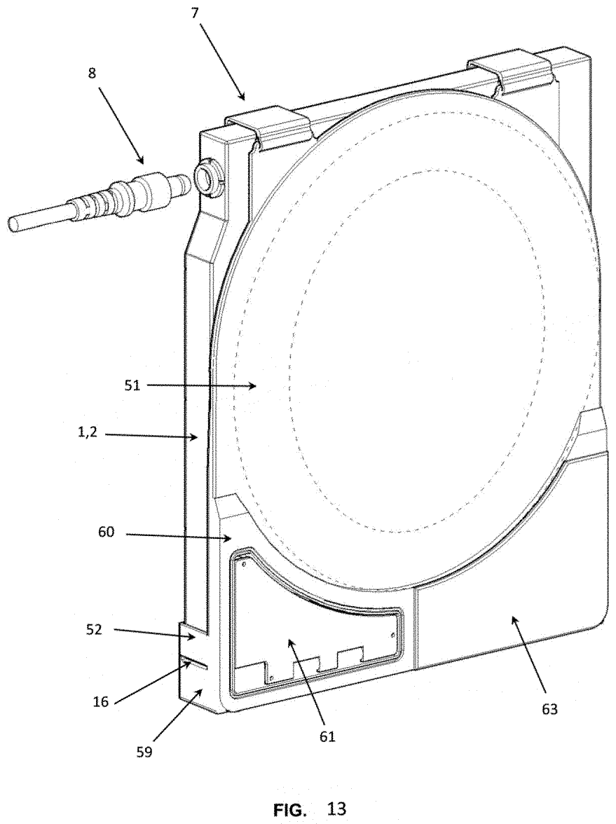

FIG. 13 shows an alternate configuration for the wireless power RX coil 51 assembly housing integrated onto a high power cradle charging assembly 60. In this configuration the ACV signal received by the RX coil 51 is rectified by the rectification board assembly 61, shown without a housing cover and a Li charger circuit board (not shown) that would be under example cover 63. DCV charge output from the Li charging circuit is then provided to the high power charge terminals within the cradle component housing 59. Instead of the rectification circuit board and Li charger circuit board being contained within the component housing under the battery cradle 52, they are mounted in a separate housings below the RX coil 51.

### REFERENCED SPECIFICATIONS AND STANDARDS

1. MIL-PRF-32383/4. Battery, Rechargeable, Sealed, Conformal Wearable Battery (CWB), BB-2525. No enabled versions. United States Department of Defense, 2022. Retrieved from: Standards Central https://publishers.standardstech.com/content/military-dod-mil-prf-32383-4. Accessed: 2022 Apr. 2012
2. IP68 as defined in: International Electrical Commission (IEC) 60529. Degrees of Protection Provided by Enclosures (IP Code), Edition 2.1, 2001 February
3. Qi Standard, Wireless Power Consortium, https://www.wirelesspowerconsortium.com
4. AirFuel Alliance AFA TS-0010-A V2.00, AirFuel Alliance Resonant Wireless Power Transfer (WPT) System Baseline System Specification (BSS). Jul. 25, 2018, https://airfuel.org
5. SMBus configuration protocols as described in: System Management Bus (SMBus) Specification, version 3.1. 19 Mar. 2018. http://smbus.org/specs/6.
6. Smart Battery Charger Specification, version 1.1, August 1999, http://sbs.forum.org/specs/legacy.html

What is claimed is:

1. A wearable battery charging system for charging a battery which is sized to fit into a pocket on a tactical vest,
wherein the pocket has an opening into a pocket cavity and the pocket cavity has a cavity base at the bottom of the cavity, and
wherein the pocket is sized to fit onto a torso covering surface on the vest and wherein the battery has a base, and
wherein the battery and pocket are adapted so that the battery is held snugly within the pocket when the vest is worn, the wearable battery charging system co-operating with a wireless power transmitting coil and associated electronics detached from the vest, the wearable battery charging system comprising:
a battery charging cradle having within it a rectification circuit, a battery charging circuit, and a wireless power receiving planar coil,
wherein the power receiving planar coil is sized for optimized wireless power charging of the battery when the power receiving planar coil within the cradle is brought into charging proximity to, and charging alignment with so as to be parallel to, the wireless power transmitting coil the power receiving planar coil in the cradle, and
wherein the cradle is sized and shaped to correspond to the size and shape of the base of the battery and to fit snugly against the base of the battery so as to lie in a plane of the battery, and is adapted to transfer power from the power receiving planar coil to the battery when snugly against the base of the battery, and
wherein the cradle is sized to snugly fit within the cavity base of the pocket and to be compressed into the cavity base by the battery, and
wherein an outer circumferential dimension of the cradle substantially corresponds to an outer circumferential dimension of the base of the battery so that the cradle is conformal with the base of the battery when the power receiving planar coil is snugly adjacent against a face of the battery which is adapted for transfer of power to the battery and the battery and the cradle are mounted in the pocket of the vest so as to compress the cradle into the cavity base of the pocket.

2. The system of claim 1 further comprising a releasable securing means adapted to releasably secure the battery onto the cradle when the battery and the cradle are mounted in the pocket.

3. The system of claim 1 wherein the cradle has a battery interface on a surface of the cradle facing the battery when the battery is on the cradle, and wherein the battery interface has a battery receiving cavity into which the base of the battery snugly fits.

4. The system of claim 1 wherein the wireless power receiving planar coil has a diameter which is at least five inches.

5. The system of claim 4 wherein the wireless power receiving planar coil, the rectification circuit and the battery charging circuit are adapted to receive wireless power from the wireless power transmitting coil, and to provide the received power to the battery in the range of zero to 300 Watts.

6. The system of claim 5 wherein the pocket is located on the rear of the vest.

7. The system of claim 6 wherein the pocket covers greater than one quarter of the surface area of the rear of the vest.

8. The system of claim 7 wherein the battery has a battery width, a battery height, and a battery depth, and
wherein the battery depth is less than one fifth of the battery width, and wherein the cradle has a cradle width, a cradle height, and a cradle depth, and
wherein the battery width is the same as the cradle width, and wherein the battery depth is the same as the cradle depth, and wherein the pocket cavity is correspondingly sized to receive snugly in the pocket cavity the battery and the cradle when the battery is mounted on the cradle.

9. The system of claim 1 wherein the method for wireless power transfer is chosen from the group comprising: inductive at operating frequencies between 20 kHz to 500 kHz, magnetic resonance at operating frequencies between 6 MHz to 7 MHz, magnetic resonance at operating frequencies between 13 MHz to 14 MHz.

10. The system of claim 1 wherein the cradle does not have any cables leading into or out of the cradle.

11. The system of claim 10 further comprising a data exchange and power-out connector on the cradle.

12. The system of claim 1 wherein the battery has a curvature to conform to a curvature of the torso of a user, and wherein the cradle has a corresponding curvature.

13. The system of claim 12 wherein the cradle is manufactured from material chosen from the group consisting of: rigid material, semi-rigid material.

14. The system of claim 2 wherein the releasable securing means is chosen from the group comprising: strap, straps, latch between the battery and cradle, releasable adhesive, hook and loop fasteners, male-female mating between the battery and cradle, rigid arm, rigid arms with interlocking releasable mating of the arms, a tensioning fold-over pocket flap to push the battery and cradle into the cavity base of the pocket.

15. The system of claim 8 wherein the cradle width is less than the battery width.

16. The system of claim 1 wherein the system does not include a wireless power coil or rectification circuit and is adapted so the battery charging circuit receives power in the range of zero to 300 Watts from an external cable coupled to the cradle.

17. The system of claim 16 further comprising a data exchange and power-out connector on the cradle.

18. The system of claim 16 wherein the battery has a curvature to conform to a curvature of the torso of a user, and wherein the cradle has a corresponding curvature.

19. The system of claim 16 further comprising releasable securing means chosen from the group comprising: strap, straps, latch between the battery and cradle, adhesive, hook and loop fasteners, male-female mating between the battery and cradle, rigid arm, rigid arms with interlocking releasable mating of the arms, a tensioning fold-over pocket flap to push the battery and cradle into the cavity base of the pocket.

20. The system of claim 16 wherein the cradle has a width which is less than a width of the battery.
